(19) United States
(12) Patent Application Publication
(10) Pub. No.: US 2011/0099195 A1
(43) Pub. Date: Apr. 28, 2011

(54) Method and Apparatus for Video Search and Delivery

(76) Inventors: Chintamani Patwardhan, Saratoga, CA (US); Thyagarajapuram S. Ramakrishnan, Saratoga, CA (US)

(21) Appl. No.: 12/910,319

(22) Filed: Oct. 22, 2010

Related U.S. Application Data
(60) Provisional application No. 61/254,204, filed on Oct. 22, 2009.

(51) Int. Cl. G06F 17/30

(52) U.S. Cl. 707/769; 707/E17.014

(57) ABSTRACT

The embodiments herein disclose a comprehensive system and process of archiving, indexing, searching, delivering, ‘personalization and sharing’ of sports video content over the Internet. The method comprises steps of providing search friendly sports video content, said method comprising steps of identifying logical events and segmenting said one or more videos into a plurality of video segments based on pre-defined criteria; generating quantitative and qualitative meta data for said video segments; storing said video segments along with said quantitative and qualitative meta data; receiving a query from a user with one or more keywords; analyzing said query from said user to extract meta data for searching relevant video segments; obtaining relevant video segments based on said generated meta data from said keywords of said query; presenting said relevant video segments as a result set.

### CROSS REFERENCE TO RELATED APPLICATION

This application claims the benefit of U.S. Provisional Application No. 61/254,204 filed on Oct. 22, 2009, which is herein incorporated by reference.

### TECHNICAL FIELD

The present invention relates to video content. More specifically, it relates to the processing, search, delivery and consumption of sports video content over the Internet.

### BACKGROUND

Over the past few years, there has been a great explosion in the number of websites providing access to video content that is both professionally produced as well as amateur footage. However, the typical delivery of sports video over the internet is carried over from the television format. The videos available are available in the form of live footage or edited highlights. Consider a video highlight of a soccer game, which will mostly contain just the goals, cautions, missed goals and other notable incidents which occurred in the game.

There hasn't been progress in the ability to use the inherent flexibility of the internet medium to deliver customized video content suited to individual viewing patterns of the audience. While some solutions involve the use of search on the text and other meta-data around that video content, these search solutions are very generic and do not utilize the domain specific information that a video may contain. This greatly limits the usefulness and accuracy of the solution. Further, the metadata associated with each video has to be manually entered, which entails a person watching the video and coming up with the metadata.

### BRIEF DESCRIPTION OF THE FIGURES

The embodiments herein will be better understood from the following detailed description with reference to the drawings, in which:

FIGS. 1 and 2 illustrate systems, according to embodiments as disclosed herein;

FIGS. 3, 4, 5 and 6 are flowcharts, according to embodiments as disclosed herein; and

FIG. 7 is a set of screenshots, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

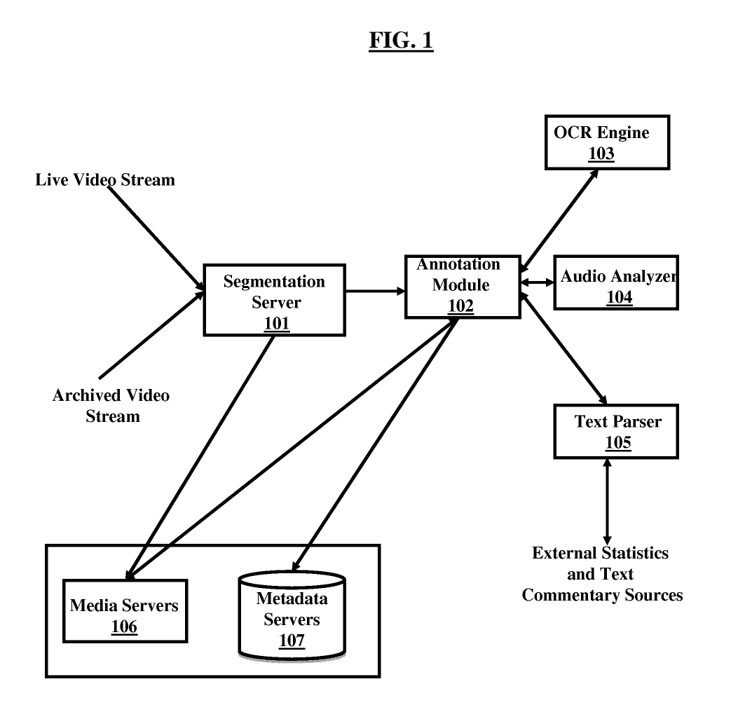

The embodiments herein disclose a comprehensive system and process of archiving, indexing, searching, delivering, ‘personalization and sharing’ of sports video content over the Internet. Referring now to the drawings, and more particularly to FIGS. 1 through 7, where similar reference characters denote corresponding features consistently throughout the figures, there are shown embodiments.

FIG. 1 depicts a system, according to embodiments as disclosed herein. The system, as depicted comprises of a segmentation server 101, an annotation module 102 and a plurality of servers. The segmentation server 103 may be connected to a source of a live video stream and an archived video stream. The annotation module 102 may be connected to the segmentation server 101, an Optical Character Recognition (OCR) engine 103, an audio analyzer 104 and a text parser 105. The text parser 105 may be further connected to an external statistics and text commentary source. The servers comprise of a media server 106 and a metadata server 107.

The segmentation server 101 may source videos from either the live video stream or the archived video stream. The live video stream may be a broadcaster of live content, such as a television channel, an internet television channel or an online video stream. The archived video stream may be a database containing videos such as a memory storage area. The segmentation server 101 may also receive videos from a user through memory storage and/or transfer means. The segmentation server 101 on receiving the video splits the video into a plurality of logical segments. The logical video segments may be created on the basis of time or nature of play and so on. For example, the video segments may be of 1 minute each. In another example, each video segment may comprise of one ball of a cricket match. The video segments may be stored by the segmentation server 101 in the media server 106.

The video segments may be passed out onto the annotation module 102. The annotation module 102 may also fetch the video segments from the video server 106. The annotation module 102 collects and assigns relevant metadata to the video segments. The metadata, as assigned by the annotation module 102 comprises of textual data such as descriptive text, entity names, event types etc. For a video segment related to a cricket match, the metadata may be scoreboard outcome, team1, team2, winning team, match status, game type, tournament name, stroke type, delivery type, dismissal type, outcome type, player specialization, run tally, runs, run rate, striker statistics, non striker statistics, bowler statistics, balls, extras, batsman ranking, bowler ranking, different types of runs scored by batsman, number of runs given by bowler, number of wides, number of no-balls, number of overs, number of maidens, number of wickets taken by bowler and so on.

The annotation module 102 may use recognizable patterns in audio (such as rise in volume or pitch) may be detected and used as meta-data, with the help of the audio analyzer 104. An embodiment may use more than one such audio analysis techniques to extract meta-data. Thus, in this embodiment, meta-data extraction yields a searchable archive that represents the action occurring in the video. Ancillary text content can be used as a source of meta-data. Sports events are typically accompanied by text content in the form of match reports, live commentary as text, match statistics, etc. which contain information such as the teams involved, the players involved, etc.

The annotation module 102 may analyze one or more such sources of text content to extract relevant meta-data about the video, using the text parser 107. The text parser 107 may use external references such as statistical sources, commentary sources and so on. The statistical sources may be a scorecard of match to which the video segment currently being analyzed belongs. The commentary source may be an online text based commentary of the match to which the video segment currently being analyzed belongs.

The annotation module 102 further analyzes the video data using various techniques like OCR with the assistance of the OCR engine 103 to derive meta-data about the events occurring in the video. Sports video contains information such as the current score, time of play, etc., overlaid as text captions on the video content. The OCR engine 103 uses OCR techniques to parse such text captions and extract meta-data from them.

In another embodiment herein, the automated techniques as described above may be augmented by human input to evaluate meta-data generated by the automated techniques and ensure the meta-data is correct.

In another embodiment herein, the automated techniques as described above may be augmented by using human input to assign ratings, subjective criteria and other such elements to video content.

Sports video typically is accompanied by an audio commentary track that describes the action occurring in the video. In another embodiment herein, the audio track is first converted to recognizable words (as text) using speech to text analysis and voice recognition technologies. Following conversion of speech to text, the text is correlated to the video by noting the time information in the video and audio streams.

Once the annotation module 102 has performed the annotation, the annotation module 102 sends the media and the metadata to the media server 106 and the metadata server 107 respectively. The media and the metadata are linked with each other, using a suitable means.

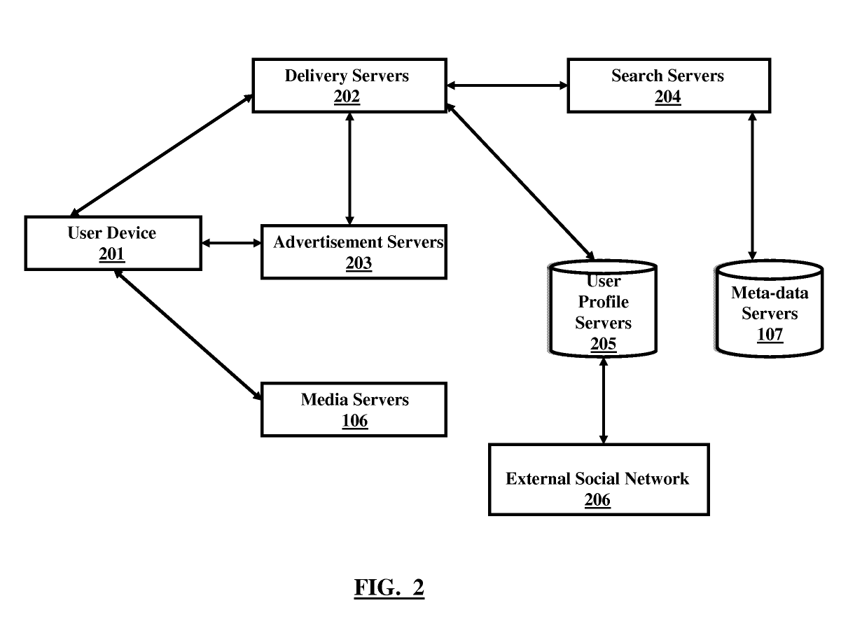

FIG. 2 depicts a system, according to embodiments as disclosed herein. The system, as depicted, comprises of a delivery server 202, an advertisement server 203, media server 106, a user profile server 205, a search server 204 and the metadata server 108. A plurality of user devices 201 may be connected to at least one of the servers. The user device 201 may be one of several possible interfaces including but not limited to a computer, a hand-held device such as a mobile phone or a PDA or a netbook or a tablet computer, a television screen, or through a set-top box connected to a monitor. The user profile server 205 may be connected to an external social network.

A user sends a search query using the user device 201 to the delivery server 202. The delivery server 202 forwards the search query to the search server 204. The search server 204 searches across stored meta-data in the metadata server 108 using the search query and suitable matches are retrieved from the media server 106. On retrieving the results from the media server 106, the search server 204 may sort the set of video segments that match a user's search query according to some criteria—increasing or decreasing popularity, chronological order, relevance to search query, ranking and rating of video content etc. The criteria for sorting the video segments may be chosen by the user and may be specified by the user in the search query.

The video segments may also be formed into a single video stream in such a way that all of the videos in the result set play consecutively in the merged video. The video stream may be in a sequence as determined by the sorting criteria. The result set of video segments may be merged according to the duration of the merged video file or video stream. Here the user may be able to specify the duration of the merged video file (or video stream) and the embodiment would judiciously choose video content from the result set in such a manner that the merged file (or video stream) obtained from the result set meet the duration criterion specified by the user. In another embodiment herein, the result set of video segments may be merged in such a manner that the discrete event boundaries between different video segments, which would otherwise be noticeable in the merged video segment, disappear.

In another embodiment herein, the system may generate a set of video segments based on the meta-data associated with the segments. For example, the system may select a set of video segments from all the segments of a particular game and display those segments in chronological order as the “highlights” of the game. For example, the highlights of a particular cricket match may be the chronological presentation of video segments containing the fall of wickets, fours, sixes, etc from the game.

In an embodiment herein, the user may consume either one video stream at a time or more than one video stream at a time simultaneously.

In an embodiment herein, the user may be given the controls to play the video segment at various speeds including slow motion (play at a speed slower than real-time)

In another embodiment herein, the interface may introduce video advertisements between the sports video segments or superimposed over a portion of the screen playing the video from the advertisement server 203. The frequency and timing of these video advertisements may be determined based on a number of criteria including, but not limited to, the content, or the user profile, or the geographical location of the user.

In another embodiment herein, the system may generate a list of video segments about a particular topic including, but not limited to, a player, a team or a venue and then present them in an order based on the meta-data associated with the segments, to create a “Best of” reel.

In another embodiment, the user may be provided the ability to tag specific video segments to create a “watch list”, and get notifications when anything changes with the clip or similar tags are applied to other clips.

In a particular embodiment, the user may be given the ability to create a collection of video segments in the form of a “reel”. The consumer can create a personalized reel of video clips of the entire results returned by a search query. The user may also pick and choose specific segments from the query results and add them to a reel. The user may create a personalized reel from the query results and reels created by other users. The user may be given the ability to name each reel and add an introductory comment to each reel. The user may be given the ability to edit all components of a reel including, but not limited to, the name, comment, list of video segments and ordering of the video segments in the reel.

The set of video segments/video stream that comprise the result set for the search query may be delivered to the user using an identification code. The video segments/video stream is fetched from the media server 106 with the reference of the identification code and displayed by the user device 201 to the user in the form of a video stream, in a continuous fashion, in the sequence determined by the sorting criteria.

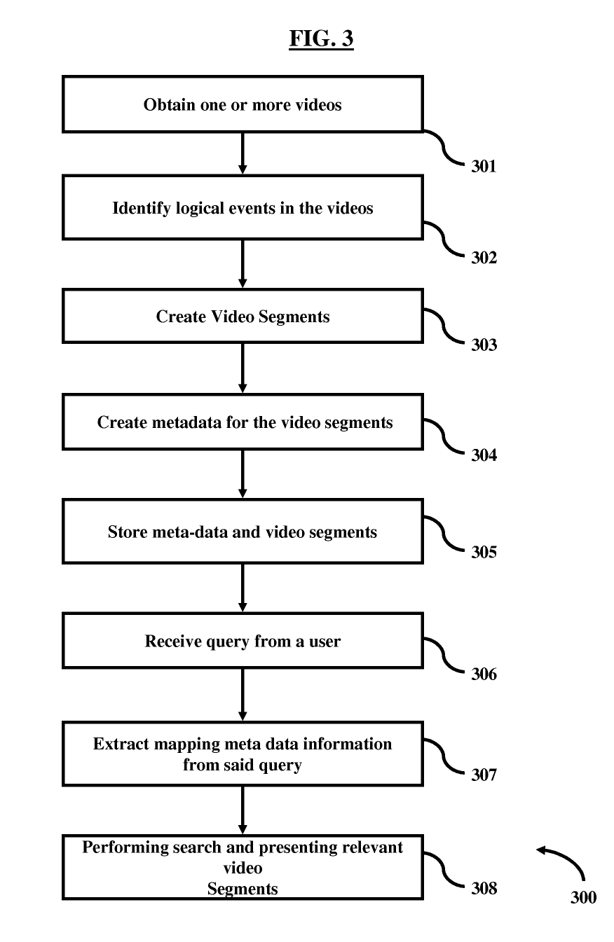

FIG. 3 depicts a flowchart, according to embodiments as disclosed herein. The segmentation server 101 obtains (301) the videos from a source, which may either be the live video stream or the archived video stream. The segmentation server 101 then identifies (302) logical segments in the obtained video. The logical segments may be identified on the basis of time or nature of play and so on. For example, the video segments may be of 1 minute each. In another example, each video segment may comprise of one ball of a cricket match or one over or one segment. Based on the identified logical segments in the video, the segmentation server 101 creates (303) video segments from the obtained video stream. The segmentation server 101 sends the video segments to the annotation module 102, which then creates (304) metadata for the video segments. The metadata, as assigned by the annotation module 102 comprises of textual data such as descriptive text, entity names, event types etc. The annotation module 102 then stores (305) the metadata and the video segments in the metadata and media servers respectively. In some embodiments the metadata and media may be stored on a single server. Further, a user query for videos may be received (306). The keywords of the search query may be analyzed to extract mapping metadata information (307) using which search for relevant video segments may be performed (308) to present to the user. A query may contain general keywords that may not directly map onto one or more of metadata fields. Therefore, each keyword of a user query is interpreted to extract relevant metadata fields that are subsequently used to perform search for relevant videos. Such interpretation may include but is not limited to using semantic analysis of keywords, using extended set of keywords for a given keyword based on the sport of interest, and using full forms for acronyms. The various actions in method 300 may be performed in the order presented, in a different order or simultaneously. Further, in some embodiments, some actions listed in FIG. 3 may be omitted.

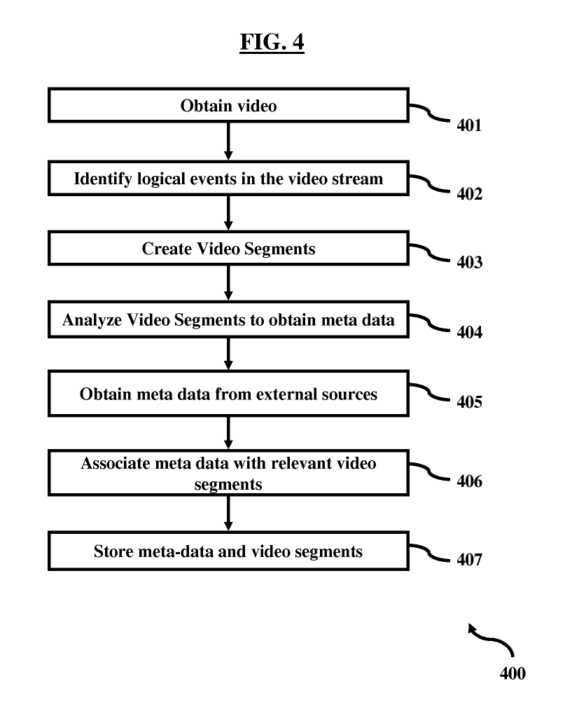

FIG. 4 depicts a flowchart, according to embodiments as disclosed herein. The segmentation server 101 obtains (401) the videos from a source, which may either be the live video stream or the archived video stream. The segmentation server 101 then identifies (402) logical segments in the obtained video. The logical segments may be identified on the basis of time or nature of play and so on. For example, the video segments may be of 1 minute each. In another example, each video segment may comprise of one ball of a cricket match or one over or one segment. Based on the identified logical segments in the video, the segmentation server 101 creates (403) video segments from the obtained video stream. In various embodiments, segments of videos may be identified using a designated camera angle or distinct sound during a game or any such identifiable characteristic in a video. For example, in cricket, at the start of a new delivery, the camera behind the bowler is used to show the game. In another example, in tennis, sound of a shot or announcement by chair umpire can be distinct from other sounds and such characteristics may be used to identify segments. The segmentation server 101 sends the video segments to the annotation module 102, which then performs a series of steps to identify metadata information. The annotation module 102 analyzes (404) the video segments to obtain metadata from the video segments themselves based on text parsing, audio analysis, and OCR analysis. The annotation module 102 may also obtain (405) metadata information from external sources for a game in a given sport. The metadata information obtained may include a combination of both quantitative metadata information and qualitative metadata information. Quantitative metadata information may include information like score of an innings in a match, result and so on. And qualitative metadata information may include information such as quality of an event like a shot (in cricket or tennis for example), state of a match (for example, power play in cricket) and so on. Further, the annotation module 102 associates (406) metadata information with relevant video segments. The metadata, as assigned by the annotation module 102 comprises of textual data such as descriptive text, entity names, event types etc. The annotation module 102 then stores (407) the metadata and the video segments in the metadata and media servers respectively. The various actions in method 400 may be performed in the order presented, in a different order or simultaneously. Further, in some embodiments, some actions listed in FIG. 4 may be omitted.

In some embodiments, the search query may be related to a specific game. In such embodiments, the result video segments may be presented as a highlights package of that particular game. The nature of video segments chosen may be predetermined by way of predefined metadata fields for selecting video segments for a particular game. The nature of video segments selected may also be based on user preferences specified either at the time of providing search query or at the time of creating his user profile.

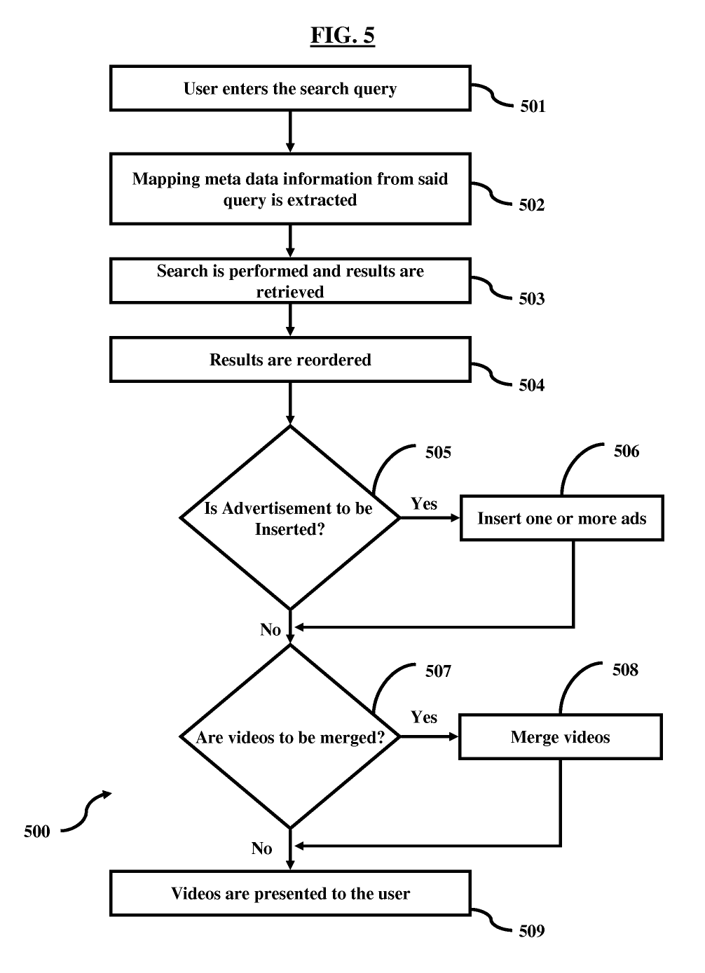

FIG. 5 depicts a flowchart, according the embodiments as disclosed herein. A user sends (501) a search query using the user device 201 to the delivery server 202. The delivery server 202 forwards the search query to the search server 204. Further, mapping metadata fields are extracted (502) from the query to use in search. The search server 204 retrieves (503) suitable matches from the media server 106. In various embodiments, results may be retrieved based on keywords that are part of the original query, extracted metadata fields, and/or user preferences that are part of a user profile. On retrieving the results from the media server 106, the search server 204 sorts (504) the set of video segments that match a user's search query according to some criteria—increasing or decreasing popularity, chronological order, relevance to search query, ranking and rating of video content etc. The criteria for sorting the video segments may be chosen by the user and may be specified by the user in the search query. In some embodiments, the criteria may also be predefined by a user in his preferences as part of his profile. In some embodiments, advertisements may be presented as part of a result list of video segments. The advertisements may be chosen to be included in a result list of video segments based on type of user account, user preferences, system configuration, user's request among others. If advertisements have to be presented as part of the result list (505), then one or more suitable advertisements are inserted in the result list of video segments (506). Further, if the user requests a single video result (507), the result video segments are merged (508) together along with any advertisements before presenting to the user. The merging of video may happen on the server side. However, in some embodiments, videos may not be merged on the served and may be played as a single video sequentially on the client side giving the impression to the user that a single video is being played.

The video segments are then presented (509) to the user in the format as specified by the user. The video segments may be presented as a single video stream or as an ordered set of video segments based on user preferences or based on options selected by the user at the time of submitting query. The video may be presented to the user in the form of identification code delivered to the user device 101. When the user wants to watch the video, the user device fetches the video using the identification code, which may be in the form of video segments or a merged video from the media server. The various actions in method 500 may be performed in the order presented, in a different order or simultaneously. Further, in some embodiments, some actions listed in FIG. 5 may be omitted.

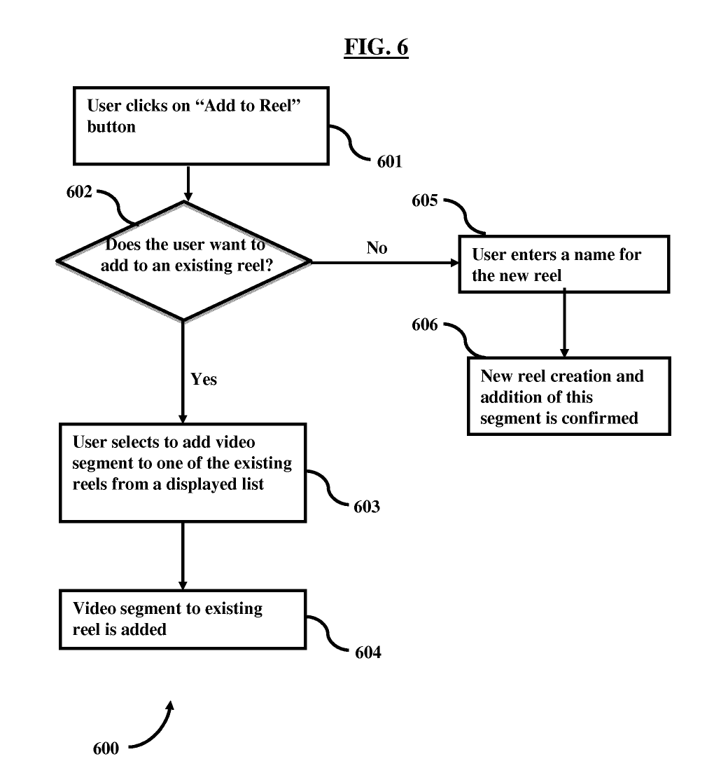

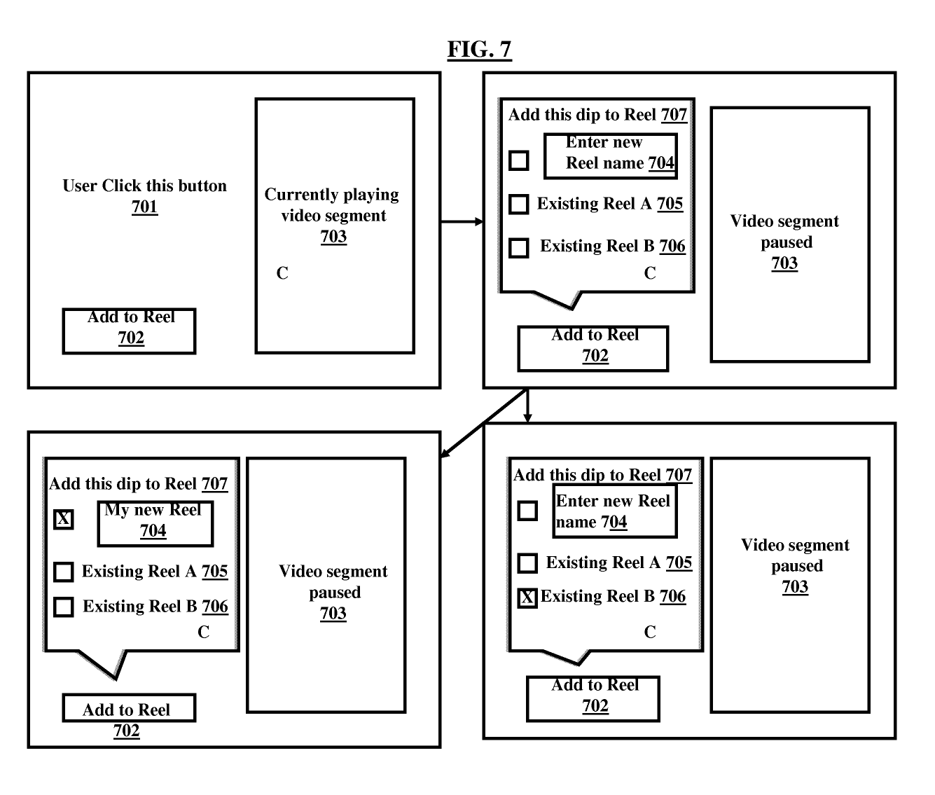

FIG. 6 depicts a flow chart, according to embodiments as disclosed herein. When the user is watching a video, the user may perform a new search to add more video segments. On being presented with more video segments, the user selects a video segment and presses (601) a button “add to reel” (as depicted in FIG. 7). On the user pressing the “add to reel”, if a video is currently playing, it is paused. It is further checked (602) if the user wants to add the selected video segment to an existing reel or to a new reel. This may be done by checking the option selected by the user as depicted in FIG. 7. If the user wants to add the selected video segment to an existing reel, then the user selects (603) a reel from a list of existing reels, which has been presented to him and video segment is added (604) to the reel. If the user wants to add the selected video segment to a new reel, then the user enters (605) a name for the new reel. The video segment is then added (606) to the new reel. The various actions in method 500 may be performed in the order presented, in a different order or simultaneously. Further, in some embodiments, some actions listed in FIG. 6 may be omitted.

A particular embodiment of all three aspects of the invention may comprise of a combination of one or more embodiments of the individual aspects. The description provided here explains the invention in terms of several embodiments. However, the embodiments serve just to illustrate and elucidate the invention; the scope of the invention is not limited by the embodiments described herein but by the claims set forth in this application.

The embodiment disclosed herein specifies a system and process of archiving, indexing, searching, delivering, ‘personalization and sharing’ of sports video content over the Internet. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein. For example, while most examples provided are related to the sport of cricket, the embodiments disclosed herein may be easily adapted to many other sports like baseball, tennis among various others.

What is claimed is:

1. A method of providing search friendly sports video content, said method comprising:
identifying logical events and segmenting said one or more videos into a plurality of video segments based on pre-defined criteria;
generating quantitative and qualitative meta data for said video segments;
storing said video segments along with said quantitative and qualitative meta data;
receiving a query from a user with one or more keywords;
analyzing said query from said user to extract meta data for searching relevant video segments;
obtaining relevant video segments based on said generated meta data from said keywords of said query; and
presenting said relevant video segments as a result set.

2. The method as in claim 1, wherein said method further comprises of sorting said relevant video segments based on at least said keywords, said meta data, and preferences of said user before presenting said relevant video segments.

3. The method as in claim 1, wherein the step of generating quantitative and qualitative meta data further comprises of:
analyzing said video segments to extract quantitative and qualitative meta data;
obtaining quantitative meta data related to game of said video from at least one external source for quantitative meta data;
associating quantitative meta data from said at least one external source for quantitative meta data with relevant video segments by matching said quantitative meta data obtained by said analysis and said meta data obtained from said at least one external source for quantitative meta data;
obtaining qualitative meta data related to game of said video from at least one external source for qualitative meta data; and
associating qualitative meta data from said at least one external source for qualitative meta data with relevant video segments by matching said qualitative meta data obtained by said analysis and said meta data obtained from said at least one external source for qualitative meta data.

4. The method as in claim 1, wherein said video content is related to the sport of cricket.

5. The method as in claim 4, wherein meta data information is information about at least one of outcome of a game, team involved in a game, winning team, match status, game type, tournament name, stroke type, delivery type, dismissal type, outcome type, player specialization, run tally, runs, run rate, striker statistics, non striker statistics, bowler statistics, balls, extras, batsman ranking, bowler ranking, types of runs scored by batsman, number of runs given by bowler, number of wides, number of no-balls, number of overs, number of maidens, number of wickets taken by bowler.

6. The method as in claim 1, wherein said analysis is performed by performing at least one of text parsing, OCR analysis, and audio analysis.

7. A method of generating quantitative and qualitative meta data for a sports video, said method comprising:
identifying logical events and segmenting said video into a plurality of video segments based on pre-defined criteria;
analyzing said video segments to extract quantitative and qualitative meta data;
obtaining quantitative meta data related to game of said video from at least one external source for quantitative meta data;
associating quantitative meta data from said at least one external source for quantitative meta data with relevant video segments by matching said quantitative meta data obtained by said analysis and said meta data obtained from said at least one external source for quantitative meta data;
obtaining qualitative meta data related to game of said video from at least one external source for qualitative meta data; and
associating qualitative meta data from said at least one external source for qualitative meta data with relevant video segments by matching said qualitative meta data obtained by said analysis and said meta data obtained from said at least one external source for qualitative meta data.

8. The method as in claim 7, wherein said method further comprises of storing said video segments, and associated quantitative meta and qualitative meta in at least one database.

9. The method as in claim 7, wherein said video is a live stream of an event.

10. The method as in claim 7, wherein said video is an archived video.

11. The method as in claim 7, wherein said method further comprises of validating quantitative and qualitative meta data associated with said video segments of said video manually.

12. The method as in claim 7, wherein said video is related to the sport of cricket.

13. The method as in claim 12, wherein meta data information is information about at least one of outcome of a game, team involved in a game, winning team, match status, game type, tournament name, stroke type, delivery type, dismissal type, outcome type, player specialization, run tally, runs, run rate, striker statistics, non striker statistics, bowler statistics, balls, extras, batsman ranking, bowler ranking, types of runs scored by batsman, number of runs given by bowler, number of wides, number of no-balls, number of overs, number of maidens, number of wickets taken by bowler.

14. The method as in claim 7, wherein said analysis is performed by performing at least one of text parsing, OCR analysis, and audio analysis.

15. A method of delivering sport video segment search results based on a query from a user, said method comprising:
receiving a query from a user with one or more keywords;
analyzing said query from said user to extract meta data for searching relevant video segments;
obtaining relevant video segments based on said generated meta data from said keywords of said query; and
presenting said relevant video segments as a result set.

16. The method as in claim 15, wherein said method further comprises of sorting said relevant video segments based on at least said keywords, said meta data, and preferences of said user before presenting said relevant video segments.

17. The method as in claim 15, wherein said method further comprises of merging said relevant video segments before presenting to said user.

18. The method as in claim 17, wherein said method further comprises of inserting relevant advertisement segments between relevant video segments.

19. The method as in claim 15, wherein said method further comprises of playing said relevant video segments in sequential order automatically.

20. The method as in claim 19, wherein said method further comprises of including relevant advertisement segments between relevant video segments.

21. The method as in claim 15, wherein said method further comprising user adding at least one of said relevant video segments to an existing reel for further use.

22. The method as in claim 15, wherein said method further comprising:
creating a new reel by said user; and
adding at least one of said relevant video segments to said new reel for further use by said user.

23. The method as in claim 15, wherein said method further comprising presenting said relevant video segments in a comparative mode wherein relevant segments are played in parallel.

24. The method as in claim 15, wherein said method further comprising the step of limiting the time duration of said video segments of said result set to a duration specified by said user by selecting most relevant video segments that fit into said time duration based on at least one of said meta data generated and preferences of said user.

25. The method as in claim 15, wherein said sport is cricket.

26. The method as in claim 25, wherein meta data information is information about at least one of outcome of a game, team involved in a game, winning team, match status, game type, tournament name, stroke type, delivery type, dismissal type, outcome type, player specialization, run tally, runs, run rate, striker statistics, non striker statistics, bowler statistics, balls, extras, batsman ranking, bowler ranking, types of runs scored by batsman, number of runs given by bowler, number of wides, number of no-balls, number of overs, number of maidens, number of wickets taken by bowler.

27. A method of delivering a personalized highlights segment of a game, said method comprising:
receiving a query from a user with one or more keywords related to a game;
analyzing said query from said user to extract meta data for searching relevant video segments related to said game;
obtaining relevant video segments based on said generated meta data from said keywords of said query; and
presenting said relevant video segments as a highlights package for said game.

28. The method as in claim 27, wherein said method further comprises of merging said relevant video segments before presenting to said user.

29. The method as in claim 28, wherein said method further comprises of inserting relevant advertisement segments between relevant video segments.

30. The method as in claim 27, wherein said method further comprises of playing said relevant video segments in sequential order automatically.

31. The method as in claim 30, wherein said method further comprises of including relevant advertisement segments between relevant video segments.

32. The method as in claim 27, wherein said method further comprising user adding at least one of said relevant video segments to an existing reel for further use.

33. The method as in claim 27, wherein said method further comprising:
creating a new reel by said user; and
adding at least one of said relevant video segments to said new reel for further use by said user.

34. The method as in claim 27, wherein said method further comprising the step of limiting the time duration of said video segments of said result set to a duration specified by said user by selecting most relevant video segments that fit into said time duration based on at least one of said meta data generated and preferences of said user.

35. The method as in claim 27, wherein said game is a game of cricket.

36. The method as in claim 35, wherein meta data information is information about at least one of outcome of a game, team involved in a game, winning team, match status, game type, tournament name, stroke type, delivery type, dismissal type, outcome type, player specialization, run tally, runs, run rate, striker statistics, non striker statistics, bowler statistics, balls, extras, batsman ranking, bowler ranking, types of runs scored by batsman, number of runs given by bowler, number of wides, number of no-balls, number of overs, number of maidens, number of wickets taken by bowler.

37. A system for providing search friendly sports video content, said system comprising at least one means for:
identifying logical events and segmenting said one or more videos into a plurality of video segments based on pre-defined criteria;
generating quantitative and qualitative meta data for said video segments;
storing said video segments along with said quantitative and qualitative meta data;
receiving a query from a user with one or more keywords;
analyzing said query from said user to extract meta data for searching relevant video segments;
obtaining relevant video segments based on said generated meta data from said keywords of said query; and
presenting said relevant video segments as a result set.

38. A system for generating quantitative and qualitative meta data for a sports video, said system comprising at least one means for:
identifying logical events and segmenting said video into a plurality of video segments based on pre-defined criteria;
analyzing said video segments to extract quantitative and qualitative meta data;
obtaining quantitative meta data related to game of said video from at least one external source for quantitative meta data;
associating quantitative meta data from said at least one external source for quantitative meta data with relevant video segments by matching said quantitative meta data obtained by said analysis and said meta data obtained from said at least one external source for quantitative meta data;
obtaining qualitative meta data related to game of said video from at least one external source for qualitative meta data; and
associating qualitative meta data from said at least one external source for qualitative meta data with relevant video segments by matching said qualitative meta data obtained by said analysis and said meta data obtained from said at least one external source for qualitative meta data.

39. A system for delivering sport video segment search results based on a query from a user, said system comprising at least one means for:
receiving a query from a user with one or more keywords;
analyzing said query from said user to extract meta data for searching relevant video segments;
obtaining relevant video segments based on said generated meta data from said keywords of said query; and
presenting said relevant video segments as a result set.

40. A system for delivering a personalized highlights segment of a game, said system comprising at least one means for:
receiving a query from a user with one or more keywords related to a game;
analyzing said query from said user to extract meta data for searching relevant video segments related to said game;
obtaining relevant video segments based on said generated meta data from said keywords of said query; and
presenting said relevant video segments as a highlights package for said game.
